(19) United States
(12) Patent Application Publication
(10) Pub. No.: US 2005/0264972 A1
(43) Pub. Date: Dec. 1, 2005

(54) Relay control device for a direct current electrical apparatus

(76) Inventors: Xavier Boulesteix, Cerdon Du Loiret (FR); Mickael Lebourgeois, Auvilliers En Gatinais (FR); Damien Gatien, Pressigny Les Pins (FR)

Correspondence Address: CARLSON, GASKEY & OLDS, P.C., 400 WEST MAPLE ROAD, SUITE 350, BIRMINGHAM, MI, 48009, US

(21) Appl. No.: 11/129,031

(22) Filed: May 13, 2005

(30) Foreign Application Priority Data
May 28, 2004 (FR) 04 05 795

(51) Int. Cl. H02H 3/22

(52) U.S. Cl. 361/111

(57) ABSTRACT

A device for electrically controlling the switching of an apparatus, such as a DC motor of a vehicle window regulator controlled by an electromechanical relay, includes the electromechanical relay to actuate the switching of a switch of the apparatus and a microcontroller that controls the relay. The microcontroller periodically measures a voltage at terminals of the apparatus and delays actuation of the relay to open the switch when a voltage spike at the terminals of the apparatus during operation is above a predetermined threshold value.

### REFERENCE TO RELATED APPLICATIONS

[1] This application claims priority to French Patent Application FR 04 05 795 filed on May 28, 2004.

### BACKGROUND OF THE INVENTION

[2] The present invention relates generally to a device for controlling an electrical relay connected with an apparatus that is designed to operate in direct current DC at a nominal voltage delivered by a battery, for example 12V or 42V, etc.

Batteries of motor vehicles conventionally deliver 12V in direct current, and electrical apparatus arranged in motor vehicles therefore conventionally operate on 12V DC. “Electrical apparatus” generally means all of the vehicle-mounted electrical apparatus and electronic circuits.

Vehicle-mounted electronic circuits must be subjected to various tests in order to be validated. These tests can be prescribed by standardization authorities or by the producers themselves. For example, one test that is specific to the electronic components mounted in motor vehicles includes operating the different components at the time the battery is disconnected and while the engine is operating and driving the alternator. This test, prescribed by ISO standard 7637-2.2, is known by the name “load dump pulse.” Disconnecting the battery while the alternator is operating produces a strong electrical pulse in the vehicle supply system with a relatively steep rising slope, hence the name “load dump pulse.”

The graph in FIG. 1 represents a pulse produced by this test, such as a pulse that can occur at the terminals of the various electronic circuits normally supplied by the battery. The voltage Ua represents the nominal supply voltage of the vehicle supply system. When the engine is shut down, the battery conventionally provides a nominal voltage Ua of 12V. When the engine is running and driving the alternator, the nominal voltage supplied by the battery is 13.5V.

When the test is carried out by disconnecting the battery while the alternator is driven, a voltage spike with a very steep rise gradient is produced at the terminals of the different components supplied by the battery. This pulse can cause a voltage spike Vs of 21.5V with a rising edge duration less than 10 ms. The voltage at the terminals of the different components thus reaches 35V. It is necessary to wait for approximately 400 ms for this excess voltage to diminish and to return to the nominal voltage of 13.5V.

However, depending on the components of the electrical system of the vehicle, such a voltage spike Vs can be harmful. The voltage spike does not necessarily have a harmful effect if it occurs during the continuous operation of an apparatus. However, the control relays of the different electrical apparatus can be damaged if they are opened during this electrical spike.

Electrical apparatus are often controlled by a relay which switches a switch of the apparatus, such as a motor of a window regulator. The relay is an electromagnetic control device operated to switch an electrical circuit on or off. Conventionally, a relay includes a coil coupled with a magnet linked to a switch. When a control voltage is applied to the coil, the magnetic field is produced which causes the switching of the switch. Moreover, the relay also absorbs the electric arc produced by the excess voltage at the terminals of the apparatus when the electrical power supply is interrupted by opening the switch. The electric arc corresponds to a discharge between the terminals of the switch when these are separated from each other while a current flows through them. The current supplying the apparatus does not immediately become nil when the switch is open because of the capacitive or inductive load of the apparatus. This discharge can be drained off between the contacts of the relay.

Switching relays for apparatus supplied with 12V DC are components conventionally used in the automotive industry. Such relays can support up to 16V without the electric arc produced by the opening of the switches being harmful.

However, in the case of a test such as the above-mentioned “load dump pulse,” the problem of a voltage spike produced in the event of a power dump in an apparatus is accentuated. In particular, the electric arc produced in such a situation cannot be drained away between the contacts. The electric arc is still not turned off and the component can catch fire or the contacts of the switch can be welded.

A need therefore exists to provide a device for electrical control of switching of an apparatus which can protect the relay against high and localized excess voltages.

### SUMMARY OF THE INVENTION

The present invention provides a device for electrical control of switching of an apparatus operating in direct current at a predetermined voltage. The device includes an electromechanical relay to actuate the switching of a switch of the apparatus and a control for shutting down operation of the apparatus. A microcontroller controls the relay and delays control of the relay to open the switch when a voltage spike at the terminals of the apparatus during operation is above a predetermined threshold.

According to one embodiment, the microcontroller detects a voltage spike slope greater than or equal to a predetermined threshold. According to one embodiment, the microcontroller detects a voltage spike value greater than or equal to twice the supply voltage. According to another embodiment, the microcontroller includes a device for periodic measurement of the voltage at the terminals of the apparatus. According to one embodiment, the microcontroller includes a spike lookup table with excess voltage values as the input and time values characteristic of a return to a predetermined voltage as the output. According to yet another embodiment, the electrical apparatus is a motor for actuating an opening element of a vehicle.

The invention also provides a method for actuating an electrical control for the switching of an apparatus operating in direct current at a predetermined voltage. The method includes the steps of switching off the apparatus, detecting a voltage spike at the terminals of the apparatus during operation and detecting a shutdown control signal for the apparatus. If a voltage spike is detected, the relay is actuated after a time delay t_{d} to open the switch.

According to one embodiment, the step of detecting the voltage spike includes measuring a duration of a rising edge of a pulse. According to one embodiment, the step of detecting the voltage spike includes measuring a voltage value of the pulse. According to another embodiment, the delay time t_{d} is between 300 ms and 400 ms.

Other characteristics and advantages of the invention will become apparent when reading the following detailed description of embodiments of the invention, given by way of example only and with reference to the drawings.

### BRIEF DESCRIPTION OF THE DRAWINGS

FIG. 1, already described, is a graph of an electrical pulse corresponding to the test from ISO standard 7637-2.2; and

FIG. 2 is a skeleton diagram of a device according to the invention.

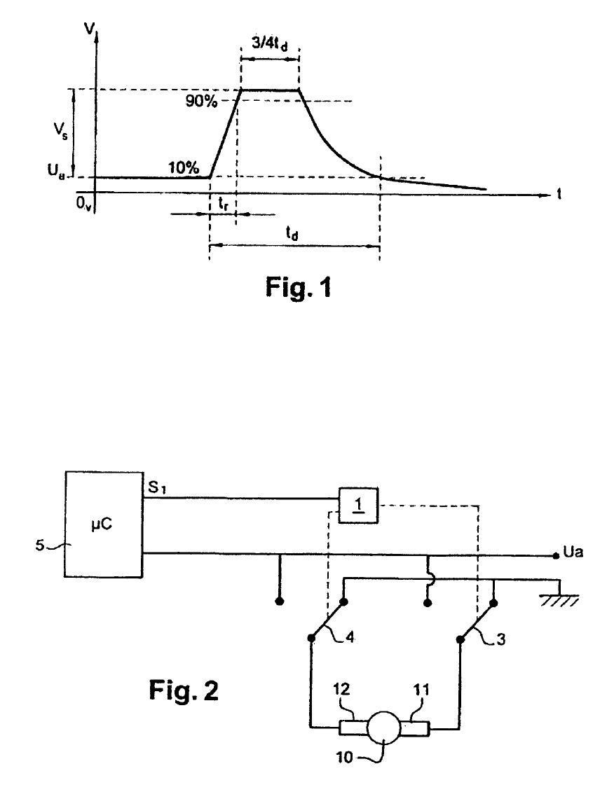

### DETAILED DESCRIPTION OF PREFERRED EMBODIMENTS

The device for electrical control of switching according to the present invention includes an electromechanical relay which actuates the switching of a switch of an apparatus operating in direct current at a predetermined voltage. The device also includes a microcontroller which controls the relay and delays control of the relay for opening the switch when the voltage at the terminals of the apparatus during operation is greater than a predetermined threshold. The device thus prevents damage to the relay that is caused by opening the switch during a voltage spike, for example, due to an electrical test of the circuits of the electrical system.

According to the invention, the switch of the relay has an open state and a closed state that are defined as states corresponding, respectively, to the passage of a supply current through the apparatus and to an interruption of the passage of the current through the apparatus. The passage of the supply current in the apparatus can be interrupted either by short-circuiting the apparatus itself or by opening the circuit.

FIG. 2 schematically illustrates an example electrical circuit for producing the device according to the invention. An apparatus, such as a motor 10 for actuating an opening element of a vehicle (for example a motor of a window regulator), should be supplied with direct current at a predetermined supply voltage Ua generally corresponding to the voltage delivered by a battery of the vehicle.

In FIG. 2, the motor 10 is shut down, and the terminals 11 and 12 of the motor 10, respectively connected to switches 3 and 4, are connected to the same point of potential.

The motor 10 is therefore short-circuited, and the switches 3 and 4 are each in the open state, according to the definition given previously.

To start the motor 10, i.e., to connect a terminal 11 of the motor 10 to the supply voltage Ua and the other terminal 12 to ground, one of the switches 3 and 4 must be switched to the closed state on a supply terminal. The direction of rotation of the motor 10 will be determined by whichever terminal 11 or 12 of the motor 10 is connected to the supply voltage Ua by switching of the corresponding switch 3 or 4 to the closed state. The other terminal 12 or 11 of the motor is connected to ground.

The switching of the switches 3 and 4 is ensured by a relay 1. In a manner known per se, the relay 1 can includes two coils each coupled with a magnet linked to one of the switches 3 and 4. Switching transistors allow a current to be applied to one of the coils to produce a magnetic field which actuates one of the switches 3 and 4 by one of the magnets.

A microcontroller 5 ensures the control of switching of the relay 1. The microcontroller 5 applies a control voltage S₁ intended to actuate one of the switching transistors connected to the relay 1 to allow a current to flow through one of the coils to actuate the switching of one of the switches 3 and 4.

The microcontroller 5 also measures the value of the supply voltage Ua. In a manner known per se, for a device analog measurement of the voltage is provided. The measurements are converted into digital values which can be used by the microcontroller 5. Preferably, the device for analog measurement periodically measures the supply voltage Ua so that the microcontroller 5 can, if appropriate, determine a slope of a rising edge of an electrical pulse. For example, the microcontroller 5 receives a voltage measurement every 3 ms. It can therefore detect the “load dump” pulse whose rising edge is of the order of 10 ms. By contrast, it is not useful to detect pulses which can have a high excess voltage value, for example up to 100V, over a very short time period of time, for example on the order of 1 to 2 ms. Such pulses are not really harmful to the relay 1, which has a reaction time of the order of 3 ms. Moreover, filtering elements connected to the power supply eliminate or at least attenuate such pulses of short duration.

Moreover, the microcontroller 5 monitors the state of operation of the motor 10. In particular, the closed state or the open state of the switches 3 and 4 which are controlled by the relay 1 and by the microcontroller 5 is known.

Thus, if the microcontroller 5 receives a shutdown control signal of the apparatus, for example if the pressure on the control button of the window regulator is relaxed, a control voltage S₁ for opening the switches 3 and 4 should be sent to the relay 1. However, according to the invention, if the microcontroller 5 has additionally detected a voltage spike at the terminals 11 and 12 of the motor 10 which is greater than a predetermined threshold, it delays sending the control voltage S₁ for a t_{d} delay time. The delay time t_{d} can be adjusted so that the electrical pulse has practically returned to the nominal voltage.

According to one embodiment, the excess voltage detected by the microcontroller 5 can be a voltage value greater than a predetermined threshold, for example twice the nominal supply voltage Ua, or can be a slope of a rising edge of a pulse greater than a predetermined slope value. If the microcontroller 5 detects a voltage spike using a measurement of the slope value, it can detect the excess voltage pulse before a voltage value harmful to the relay 1 is reached.

The embodiments depend on the programming of the microcontroller 5 according to the degree of protection needed for the relay 1 and according to the risks to the relay 1. In particular, the microcontroller 5 can be programmed to detect a given voltage value at the terminals 11 and 12 of the apparatus, a given excess voltage value, a given excess voltage pulse slope, or a combination of these elements. Such a programming can be ensured by a person skilled in the art as a function of their requirements and of the model of the relay 1 to be protected.

After the delay time t_{d} of the order of the fall time of the excess voltage pulse, the microcontroller 5 sends the control voltage S₁ towards the relay 1, which actuates the switching of the switch 3 and 4 from the open state. The current at the terminals 11 and 12 of the motor 10 then returns to a nominal value at the time of the switching, and the electric arc can be drained away in a conventional manner. The delay time t_{d} can be of the order of 300 ms to 400 ms.

The microcontroller 5 can adapt the value of the delay time t_{d} to the type of excess voltage detected. According to the excess voltage or slope value of the rising edge measured, the microcontroller 5 can deduce the type of pulse occurring. The microcontroller 5 can then determine the time for the return to the nominal voltage for such a pulse and can delay the opening control of the relay 1 as a function of the time which is specific to the pulse occurring. A spike lookup table can be stored in the microcontroller 5 for this purpose which includes excess voltage measurement at the input and times that are representative of a return to the nominal voltage at the output.

Of course, the present invention is not limited to the embodiments described by way of example. Thus, the relay 1 of the switching device according to the invention can include only one switch 3 and 4 instead of two. Moreover, by adapting the programming of the microcontroller 5, the control device according to the invention can protect the relay 1 against other types of electric pulses having different voltage and slope values.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A device for electrical control of a switch of an apparatus operating in direct current at a predetermined voltage, the device comprising:
an electromechanical relay to actuate the switch of the apparatus;
a control to shut down operation of the apparatus; and
a microcontroller to control the electromechanical relay, wherein the microcontroller delays control of the electromechanical relay to open the switch when a voltage spike at terminals of the apparatus during operation is above a predetermined threshold value.

2. The device according to claim 1, wherein the microcontroller detects a voltage spike slope greater or equal to a predetermined threshold.

3. The device according to claim 2, wherein the electrical apparatus is a motor for actuating an opening element of a vehicle.

4. The device according to claim 1, wherein the microcontroller detects a voltage spike value greater or equal to twice a supply voltage.

5. The device according to claim 4, wherein the electrical apparatus is a motor for actuating an opening element of a vehicle.

6. The device according to claim 1, wherein the microcontroller includes a device for periodically measuring a voltage at the terminals of the apparatus.

7. The device according to claim 6, wherein the electrical apparatus is a motor for actuating an opening element of a vehicle.

8. The device according to claim 1, wherein the microcontroller includes a spike lookup table with excess voltage values as the input and time values representative of a return to a predetermined voltage as the output.

9. The device according to claim 8, wherein the electrical apparatus is a motor for actuating an opening element of a vehicle.

10. The device according to claim 1, wherein the electrical apparatus is a motor for actuating an opening element of a vehicle.

11. A method for actuating an electrical control of an apparatus operating in direct current at a predetermined voltage to switch off the apparatus comprising the steps of:
detecting a voltage spike at terminals of the apparatus during operation;
detecting a shutdown control signal of the apparatus; and
actuating a relay after a time delay to actuate a switch of the apparatus to an open state if the voltage spike is detected.

12. The method according to claim 11, wherein the step of detecting the voltage spike includes measuring a duration of a rising edge of a pulse.

13. The method according to claim 12, wherein the time delay is between 300 ms and 400 ms.

14. The method according to claim 11, wherein the step of detecting the voltage spike includes measuring a voltage value of a pulse.

15. The method according to claim 14, wherein the time delay is between 300 ms and 400 ms.

16. The method according to claim 11, wherein the time delay is between 300 ms and 400 ms.
